(19) United States
(12) Patent Application Publication
(10) Pub. No.: US 2016/0375709 A1
(43) Pub. Date: Dec. 29, 2016

(54) PRINTHEAD CAMERA BRACKET

(71) Applicant: VIDEOJET TECHNOLOGIES INC., Wood Dale, IL (US)

(72) Inventors: Peter Nguyen, Glendale Heights, IL (US); Anthony Selmeczy, Roselle, IL (US); Thomas Wiegner, Saint Charles, IL (US); Joshua Harris, Dacula, GA (US); Robert Neagle, Algonquin, IL (US); Xuedong Zhan, Wilmette, IL (US); Trent Hauser, O'Fallon, IL (US); Paul Poloniewicz, Doylestown, PA (US)

(21) Appl. No.: 14/900,753

(22) PCT Filed: Jun. 24, 2014
(86) PCT No.: PCT/US2014/043780

§ 371 Date: Dec. 22, 2015

Related U.S. Application Data
(60) Provisional application No. 61/840,270, filed on Jun. 27, 2013.

(51) Int. Cl. B41J 29/393; G06K 7/14; H04N 1/00; G06K 19/06

(52) U.S. Cl. CPC B41J 29/393; G06K 19/06028; G06K 7/1413; H04N 1/00251; H04N 1/00689; H04N 1/00734; H04N 2201/0436

(57) ABSTRACT

A printer system includes a print head, the print head oriented with a first end at a height above a substrate. A support arm extends laterally with respect to the print head. A camera is disposed on the support arm a fixed height above the substrate, such that the camera can be adjusted laterally with respect to the print head. The camera is disposed at an angle with respect to vertical to the substrate. A product detect mechanism is disposed laterally on the support arm with respect to the print head. A controller is in communication with the camera and the product detect mechanism, wherein the system is configured so that the camera can verify the printing of an image on the substrate.

### BACKGROUND

The present disclosure provides a method of detecting the existence of a printed code on a product.

Printing systems are often used to print images or codes on a product, such as lot codes, bar codes, use by dates, and the like. It is often desired to automatically verify that a code has been printed, so that if the printer malfunctions, for example, an operated is notified so that he or she can fix the malfunction to both catch the products that have not been marked and minimize the amount of product that has to be reworked.

### BRIEF SUMMARY

The present disclosure provides a method of detecting the existence of a printed code on a product. In particular, the system includes a camera and a mounting system to ensure that the camera is located in the proper place and does not require adjustment.

In one aspect, a printer system includes a print head, the print head oriented with a first end at a height above a substrate. A support arm extends laterally with respect to the print head. A camera is disposed on the support arm a fixed height above the substrate, such that the camera can be adjusted laterally with respect to the print head. The camera is disposed at an angle with respect to vertical to the substrate. A product detect mechanism is disposed laterally on the support arm with respect to the print head. A controller is in communication with the camera and the product detect mechanism, wherein the system is configured so that the camera can verify the printing of an image on the substrate.

A method of verifying an image printed on a substrate includes disposing a print head with a first end at a height above a substrate. A camera is disposed on a support at a fixed height above the substrate. The camera is adjusted laterally with respect to the print head, wherein the camera is disposed at an angle with respect to vertical to the substrate. A product detect mechanism is disposed laterally with respect to the print head. An image is printed on the substrate. Communication with the camera and the product detect mechanism is controlled to use the camera to verify the printing of the image on the substrate.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a perspective view of a first embodiment of a printer system.

FIG. 2 is a top view of the printer system of FIG. 1.

FIG. 3 is a first side view of the printer system of FIG. 1.

FIG. 4 is a second side view of the printer system of FIG. 1.

FIG. 5 is a perspective view of a second embodiment of a printer system.

FIG. 6 is a top view of the printer system of FIG. 5.

FIG. 7 is a first side view of the printer system of FIG. 5.

FIG. 8 is a second side view of the printer system of FIG. 5.

FIG. 9 is a perspective view of a third embodiment of a printer system.

FIG. 10 is a perspective view of a fourth embodiment of a printer system.

FIG. 11 is a side view of the embodiment of FIG. 10.

FIG. 12A is a schematic view showing a first orientation of the system.

FIG. 12B is a schematic view showing a second orientation of the system.

FIG. 12C is a schematic view showing a third orientation of the system.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

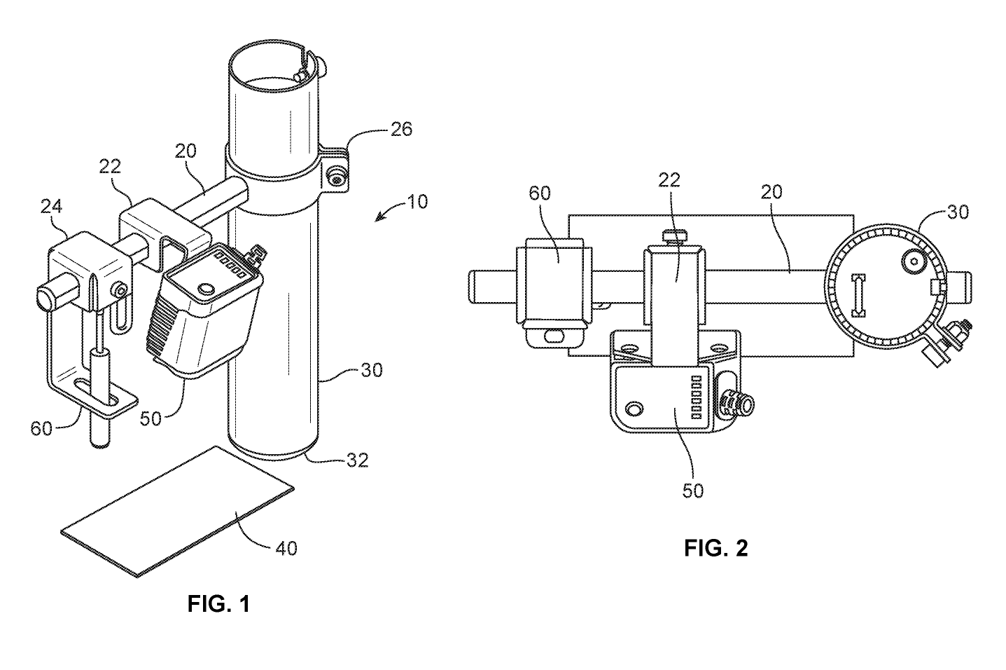

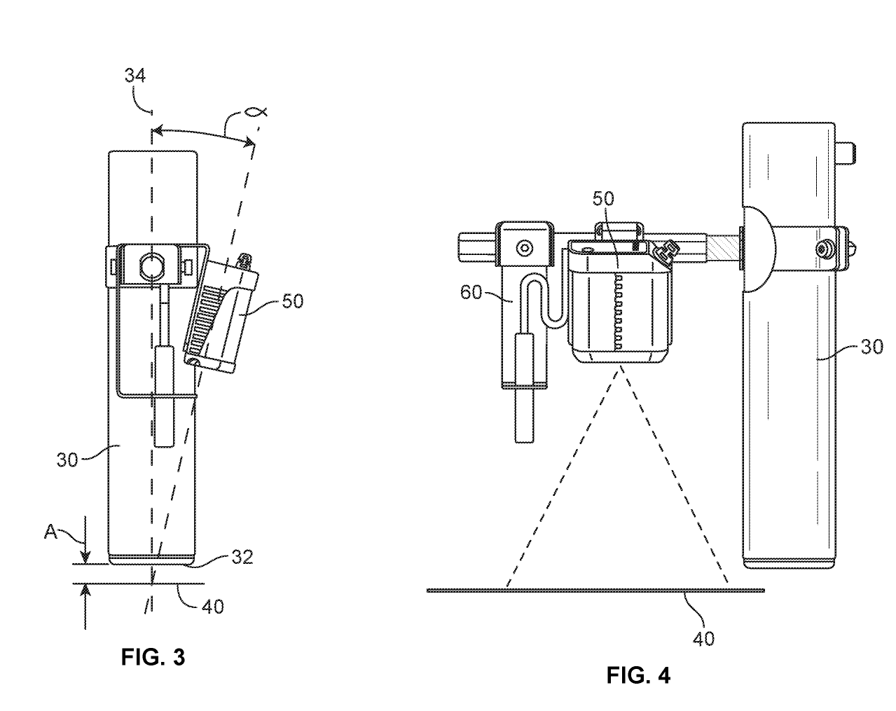

The present disclosure provides a printer system for detecting whether a code was printed on a product. In particular, the system includes a camera and a mounting system to ensure that the camera is located in the proper place relative to a substrate and does not require adjustment. An embodiment of the system is shown in FIGS. 1-4. The printer system 10 includes a print head 30, at least one support arm 20, a camera 50, and a product detect mechanism 60. The print head 30 is oriented with a first end 32 at a height above a substrate 40. The support arm 20 extends laterally with respect to the print head 30. The camera 50 is disposed on the support arm 20 a fixed height A above the substrate. The camera 50 can be adjusted laterally with respect to the print head 30. The camera 50 is disposed at an angle a with respect to a vertical axis 34 to the substrate 40.

The product detect mechanism 60 is disposed laterally in the direction of substrate movement with respect to the print head 30. A controller (not shown) is in communication with the camera 50 and the product detect mechanism 60. The system 10 is configured so that the camera 50 can verify the printing of an image on the substrate, or in other words, to identify products that are not marked by the print head. For example, if a code is not detected as printed on the substrate, the system 10 can alert an operator, stop the production line, or take other corrective action.

The camera 50 preferably has a field of view of at least 1″×3″. In one embodiment, the camera 50 is a Microscan Hawk Mini camera model. The presence of an image may be detected by any suitable methodology. The image may be detected by a machine vision methodology selected from OCR, OCV, barcode reader, pattern match, pixel counting, and presence/absence detect. The camera 50 preferably takes a snapshot image, rather than a continuous video of the substrate. In one embodiment, the system counts the number of pixels and uses a threshold to determine if the image is acceptable. For example, if X pixels are expected, the system may be set to trigger an alarm if the detected number of pixels is less than 85% of X.

The print head 30 has a feature for attaching the support arm 20 to the print head 30 such that the support arm 20 is disposed a fixed distance above the substrate 40. In one embodiment, the support arm 20 is connected to a collar 26 that encircles the print head 30. The collar 26 may rest in a circumferential groove in the print head 30 to control the fixed height of the support arm 20 (and thus camera 50) about the substrate. This arrangement ensures that the camera 50 is maintained at the proper height. Mount 22 is used to connect the camera 50 to the support arm 20 and preferably provides sliding movement with respect to the support arm 20. Mount 24 is used to connect the product detect 60 to the support arm 20 and preferably provides sliding movement with respect to the support arm 20.

The camera 50 has a fixed angle offset of between 4 degrees and 30 degrees with respect to vertical, preferably between 8 degrees and 20 degrees. In one embodiment, the camera has a fixed angle offset of 12.5 degrees with respect to vertical. In the embodiment shown in FIGS. 1-4, the fixed angle offset with respect to vertical is perpendicular to a substrate movement direction.

The product detect mechanism 60 is positioned on a support arm such that it can provide a zero-delay trigger. In other words, the print head 50 is able to respond immediately once the product detect mechanism is triggered by the substrate moving beneath. This eliminates the need for the system to compensate for any delays between triggering and image capture. The trigger can be actuated by either the leading or the trailing edge of the product. Both the print head and the camera may be activated by the same product detect, or there may be separate product detects for the print head and the camera (as disclosed below).

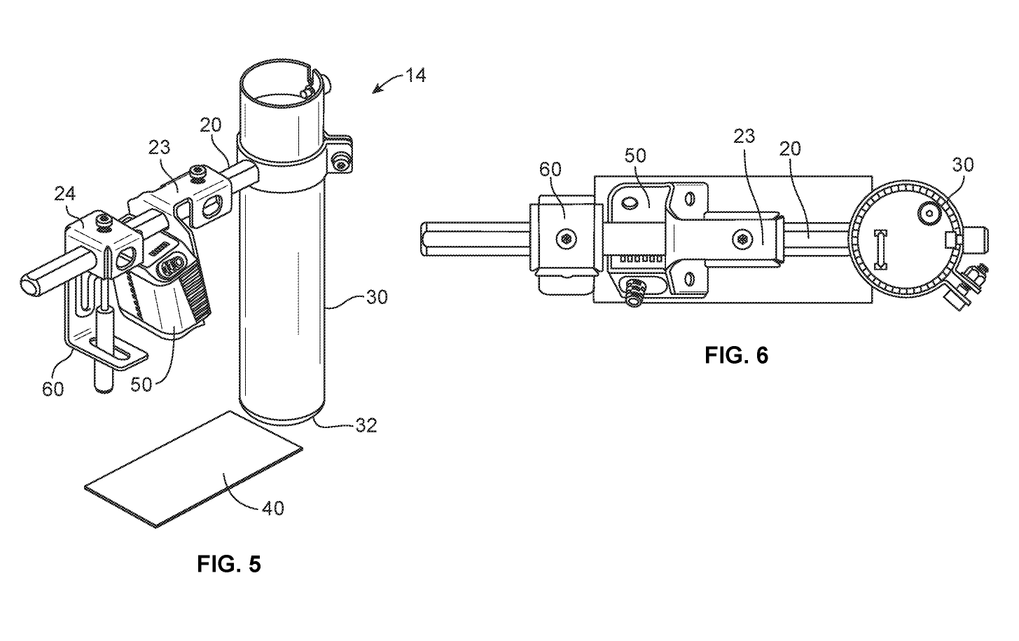

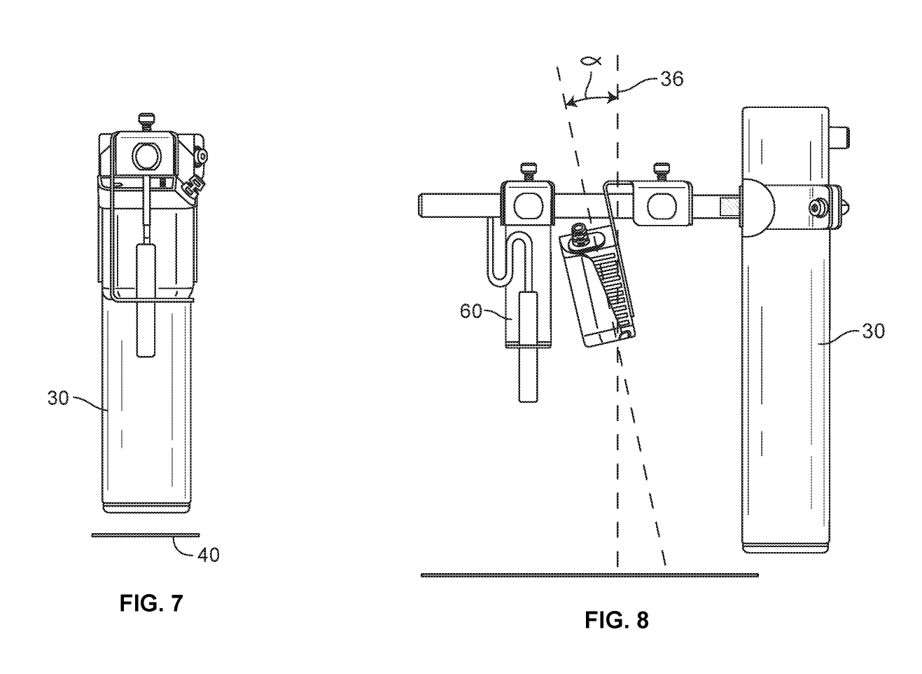

A second embodiment 14 of the system is shown in FIGS. 5-8. The embodiment in FIGS. 5-8 is similar to that shown in FIGS. 1-4 except that camera 50 is rotated 90 degrees, so that the fixed angle offset with respect to vertical is parallel to a substrate movement direction. Mount 23 is used to connect the camera 50 to the support arm 20 and preferably provides sliding movement with respect to the support arm 20. The camera 50 is disposed at an angle a with respect to a vertical axis 36 to the substrate 40.

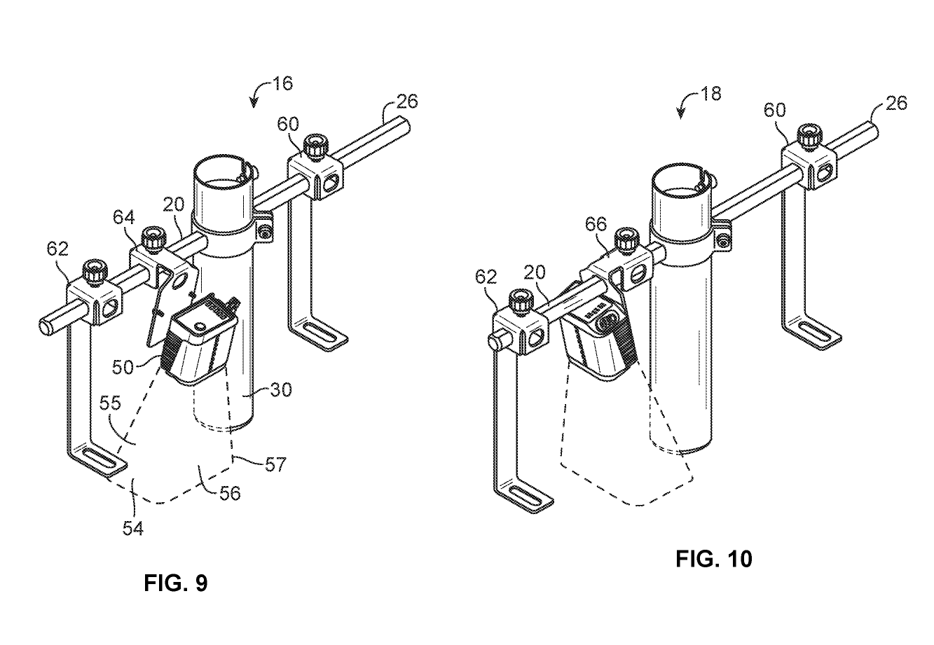

A third embodiment of a system 16 is shown in FIG. 9. System 16 includes a shroud 54 disposed over the camera 50. The shroud 50 acts to reduce the impact of changing ambient lighting conditions to improve the consistency of the camera 50. The camera consistency is improved through better signal/noise ratio and improved contrast. The shroud 54 preferably has four side walls 55, 56, 57, 58 that taper outwardly as they extends from the camera 50 to correspond to the field of view of the camera. Thus, the shroud 54 may be generally shaped as a truncated quadrilateral pyramid. The interior surface of the shroud 54 may be sandblasted or otherwise smoothed.

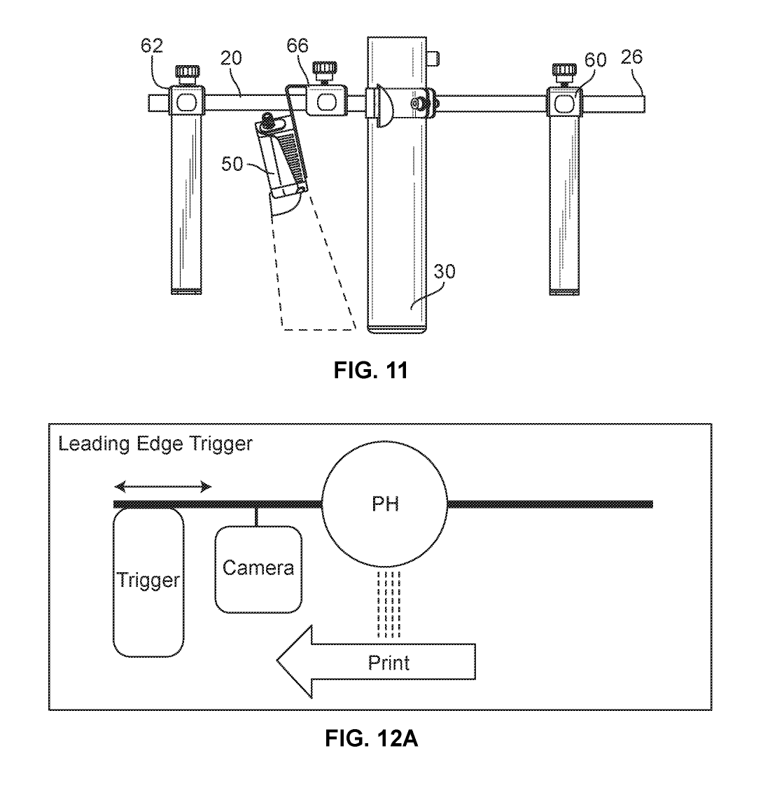

A further variation of the embodiment shown in FIG. 9 (and in FIGS. 10 and 11 below) is the inclusion of a second support arm 26. A first product detect mechanism 60 is disposed on the second support arm 26 and is located forward or upstream of the print head 50 (e.g., a moving substrate approaches the product detect 60 before it approaches the print head 30) than the embodiments shown in FIGS. 1-8. The embodiment also includes a second product detect mechanism 62 disposed on support arm 20 downstream of the print head 50. A camera mount 64 is used to support the camera 50. Like previous embodiments, camera mount 64 can slide on support arm 20.

A fourth embodiment 18 of the system is shown in FIGS. 10 and 11. The embodiment 18 is similar to embodiment 16 except that the camera 50 has been rotated 90°, so that the fixed angle offset with respect to vertical is parallel to a substrate movement direction. A camera mount 66 is used to support the camera 50. Like previous embodiments, camera mount 66 can slide on support arm 20.

Each of the systems 10, 14, 16, 18 may be used as follows. The print head 30 is disposed with end 32 at a height above the substrate 40. The camera 50 is disposed at an angle with respect to vertical to the substrate 40. The product detect 60 detects the presence of the substrate 40 and the print head 30 prints an image on the substrate. The products detect 60 (or 62 if present) also is used to activate the camera 50 to view the substrate 40 after printing to verify the presence of a printed image on the substrate 40. Communication between the camera 50 and the product detect mechanism 60 thus allows the camera 50 to verify the printing of the image on the substrate 40.

Although examples are shown using the system with a continuous inkjet system, it will be apparent that the code detect and other features of the system can be used with other types of printing technology, such as thermal inkjet, piezo inkjet, laser marking, thermal transfer printing, and the like.

### EXAMPLE

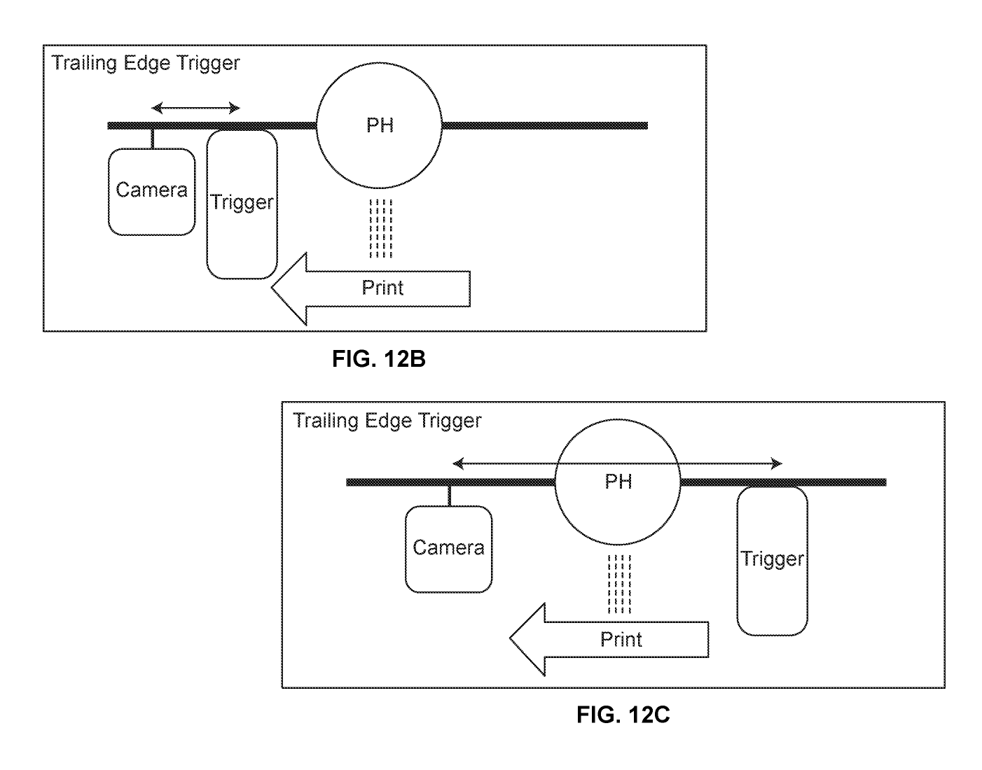

An example of the inventive system is described as follows. A system is set up on a production line for printing on moving substrates. Various orientations of the product detect, camera, and printer are illustrated in FIGS. 12A, 12B, and 12C, which represent Setup Geometries A, B, C respectfully. Examples of setups for substrates of different lengths and different speeds is shown in Table 1 below. Setup Geometry A uses a leading edge trigger, with the camera located upstream of the product detect. Setup Geometry B uses a trailing edge trigger, with the camera located downstream of the product detect. Setup Geometry C uses a trailing edge trigger, with the product detect located upstream of the printhead and the camera located downstream of the printhead.

TABLE 1

| PARAMETER | Ex. 1 | Ex. 2 | Ex. 3 | Ex. 4 | Ex. 5 | Ex. 6 |
|---|---|---|---|---|---|---|
| Setup Geometry | A | A | B | C | A | B |
| Type | leading | leading | trailing | trailing | leading | trailing |
| | edge | edge | edge | edge | edge | edge |
| Line speed/print rate | 100 fpm/60 ppm | 60 fpm/15 ppm | | | | |
| Substrate length | 4″ | 10″ | 10″ | 14″ | 6″ | 6″ |
| Distance from leading | 0.5″ | 1″ | 9″ | 7″ | 2″ | 4″ |
| edge to print location | | | | | | |
| Distance from camera | any | | | | | |
| midpoint to print | | | | | | |
| head nozzle | | | | | | |
| Distance from | any | | | | | |
| camera trigger | | | | | | |
| to print head nozzle | | | | | | |
| Distance from camera | 0.5″ | 1″ | 1″ | 7″ | 2″ | 2″ |
| midpoint to camera trigger | | | | | | |
| Height of print head | 0.25″ | 0.25″ | 0.25″ | 0.25″ | 0.1″ | 0.1″ |
| above substrate | | | | | | |
| Height of camera | 4.25″ | 4.25″ | 4.25″ | 4.25″ | 4.1″ | 4.1″ |
| above substrate | | | | | | |

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. A printer system, comprising:
a print head, the print head oriented with a first end at a height above a substrate;
a support arm extending laterally with respect to the print head;
a camera disposed on the support arm a fixed height above the substrate, such that the camera can be adjusted laterally with respect to the print head, wherein the camera is disposed at an angle with respect to vertical to the substrate;
a product detect mechanism disposed laterally on the support arm with respect to the print head; and
a controller in communication with the camera and the product detect mechanism, wherein the system is configured so that the camera can verify the printing of an image on the substrate.

2. The system of claim 1 wherein the camera has a field of view of at least 1 inch by 3 inches.

3. The system of claim 1 wherein the print head has a feature for attaching the support arm to the print head such that the support arm is disposed a fixed distance above a substrate.

4. The system of claim 1 further comprising a shroud disposed adjacent the camera to shield ambient light.

5. The system of claim 1 wherein the camera has a fixed angle offset of between 8 degrees and 20 degrees with respect to vertical.

6. The system of claim 5 wherein the fixed angle offset with respect to vertical is perpendicular to a substrate movement direction.

7. The system of claim 5 wherein the fixed angle offset with respect to vertical is parallel to a substrate movement direction.

8. The system of claim 1 wherein the product detect mechanism is located such that it can provide a zero-delay trigger.

9. The system of claim 1 wherein the system is configured such that the trigger can be used to identify products that are not marked by the print head.

10. The system of claim 1 wherein the image is detected by a machine vision methodology selected from OCR, OCV, barcode reader, pattern match, pixel counting, and presence/absence detect.

11. A method of verifying an image printed on a substrate, comprising:
disposing a print head with a first end at a height above a substrate;
disposing a camera on a support at a fixed height above the substrate;
adjusting the camera laterally with respect to the print head, wherein the camera is disposed at an angle with respect to vertical to the substrate;
providing a product detect mechanism disposed laterally with respect to the print head;
printing an image on the substrate; and
controlling communication with the camera and the product detect mechanism, to use the camera to verify the printing of the image on the substrate.

12. The method of claim 11 wherein the camera has a field of view of at least 1 inch by 3 inches.

13. The method of claim 11 wherein the print head has a feature for attaching a support arm to the print head such that the support arm is disposed a fixed distance above a substrate.

14. The method of claim 11 wherein the camera has a fixed angle offset of about 12.5 degrees with respect to vertical.

15. The method of claim 11 further comprising providing a zero-delay trigger for the camera.

16. The method of claim 11 further comprising identifying products that are not marked by the print head.

17. The method of claim 11 further comprising detecting the image by a machine vision methodology selected from OCR, OCV, barcode reader, pattern match, pixel counting, and presence/absence detect.
